(19) United States
(12) Patent Application Publication
(10) Pub. No.: US 2019/0143697 A1
(43) Pub. Date: May 16, 2019

(54) HEAD CHIP, LIQUID JET HEAD AND LIQUID JET RECORDING DEVICE

(71) Applicant: SII Printek Inc., Chiba-shi (JP)

(72) Inventors: Tomoki KAMEYAMA, Chiba-shi (JP); Yuki YAMAMURA, Chiba-shi (JP); Daichi NISHIKAWA, Chiba-shi (JP); Misaki KOBAYASHI, Chiba-shi (JP)

(21) Appl. No.: 16/185,945

(22) Filed: Nov. 9, 2018

(30) Foreign Application Priority Data
Nov. 13, 2017 (JP) 2017-218098

(51) Int. Cl. B41J 2/165; B41J 2/14

(52) U.S. Cl. CPC B41J 2/16505; B41J 2/1433

(57) ABSTRACT

There are provided a head chip, a liquid jet head, and a liquid jet recording device capable of enhancing the reliability. The head chip according to an embodiment of the disclosure includes an actuator plate having a plurality of ejection grooves arranged side by side along a first direction, and first common electrodes respectively formed in the ejection grooves, a nozzle plate having a plurality of nozzle holes individually communicated with the plurality of ejection grooves, and a cover plate adapted to cover the actuator plate. The cover plate has a wall part adapted to cover the plurality of ejection grooves. A plurality of common interconnections electrically connected to the first common electrodes is laid around on a surface on an opposite side to the actuator plate in the wall part of the cover plate, and one of a single second common electrode and a plurality of second common electrodes on the surface on the opposite side of the wall part is formed by electrically connecting at least two or more of the common interconnections to each other on the surface on the opposite side of the wall part.

### RELATED APPLICATIONS

This application claims priority under 35 U.S.C. § 119 to Japanese Patent Application No. 2017-218098 filed on Nov. 13, 2017, the entire content of which is hereby incorporated by reference.

### BACKGROUND OF THE INVENTION

### 1. Field of the Invention

The present disclosure relates to a head chip, a liquid jet head and a liquid jet recording device.

### 2. Description of the Related Art

As one of liquid jet recording devices, there is provided an inkjet type recording device for ejecting (jetting) ink (liquid) on a recording target medium such as recording paper to perform recording of images, characters, and so on (see, e.g., JP-A-2015-178219).

In the liquid jet recording device of this type, it is arranged that the ink is supplied from an ink tank to an inkjet head (a liquid jet head), and then the ink is ejected from nozzle holes of the inkjet head toward the recording target medium to thereby perform recording of the images, the characters, and so on. Further, such an inkjet head is provided with a head chip for ejecting the ink.

In such a head chip or the like, in general, it is required to enhance the reliability. It is desirable to provide a head chip, a liquid jet head, and a liquid jet recording device capable of enhancing the reliability.

### SUMMARY OF THE INVENTION

The head chip according to an embodiment of the disclosure includes an actuator plate having a plurality of ejection grooves arranged side by side along a first direction, and first common electrodes respectively formed in the ejection grooves, a nozzle plate having a plurality of nozzle holes individually communicated with the plurality of ejection grooves, and a cover plate adapted to cover the actuator plate. The cover plate has a wall part adapted to cover the plurality of ejection grooves. A plurality of common interconnections electrically connected to the first common electrodes is laid around on a surface on an opposite side to the actuator plate in the wall part of the cover plate, and one of a single second common electrode and a plurality of second common electrodes on the surface on the opposite side of the wall part is formed by electrically connecting at least two or more of the common interconnections to each other on the surface on the opposite side of the wall part.

A liquid jet head according to an embodiment of the disclosure is equipped with the head chip according to an embodiment of the disclosure.

A liquid jet recording device according to an embodiment of the disclosure is equipped with the liquid jet head according to an embodiment of the disclosure, and a containing section adapted to contain the liquid.

According to the head chip, the liquid jet head and the liquid jet recording device related to an embodiment of the disclosure, it becomes possible to enhance the reliability.

### BRIEF DESCRIPTION OF THE DRAWINGS

FIG. 1 is a schematic perspective view showing a schematic configuration example of a liquid jet recording device according to one embodiment of the disclosure.

FIG. 2 is a perspective bottom view showing a configuration example of a substantial part of the liquid jet head shown in FIG. 1.

FIG. 3 is a schematic diagram showing a cross-sectional configuration example along the line in the head chip shown in FIG. 2.

FIG. 4 is a schematic diagram showing a top surface configuration example of the cover plate shown in FIG. 3.

FIG. 5 is a schematic diagram showing a cross-sectional configuration example of the head chip along the line V-V shown in FIG. 2.

FIG. 6 is a schematic diagram showing a cross-sectional configuration example of the head chip along the line VI-VI shown in FIG. 2.

FIG. 7 is a schematic diagram showing a top surface configuration example of a cover plate related to a comparative example.

FIG. 8 is a schematic diagram showing a top surface configuration example of a cover plate related to Modified Example 1.

FIG. 9 is a schematic diagram showing a top surface configuration example of a cover plate related to Modified Example 2.

FIG. 10 is a schematic diagram showing a top surface configuration example of a cover plate related to Modified Example 3.

### DETAILED DESCRIPTION OF THE PREFERRED EMBODIMENTS

An embodiment of the present disclosure will hereinafter be described in detail with reference to the drawings. It should be noted that the description will be presented in the following order.
1. Embodiment (an example in which a second common electrode is formed in an entire area corresponding to a formation area of an ejection groove)
2. Modified Examples
   Modified Example 1 (an example in which a plurality of exposed surfaces not provided with the second common electrode is arranged at regular intervals)
   Modified Examples 2, 3 (an example in which the second common electrode is formed of common interconnections in a direction in which ejection grooves are arranged side by side)
3. Other Modified Examples

### 1. Embodiment

### [Overall Configuration of Printer 1]

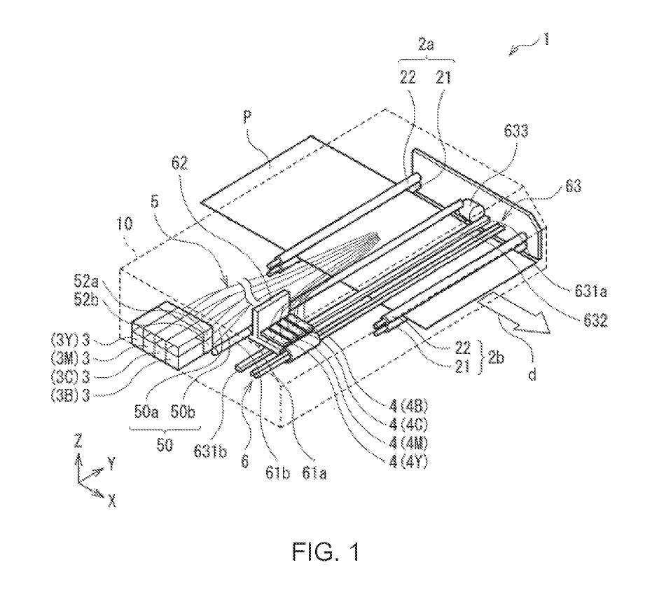

FIG. 1 is a perspective view schematically showing a schematic configuration example of a printer 1 as a liquid jet recording device according to one embodiment of the present disclosure. The printer 1 is an inkjet printer for performing recording (printing) of images, characters, and so on, on recording paper P as a recording target medium using ink 9 described later.

As shown in FIG. 1, the printer 1 is provided with a pair of carrying mechanisms 2a, 2b, ink tanks 3, inkjet heads 4, a circulation mechanism 5, and a scanning mechanism 6. These members are housed in a housing 10 having a predetermined shape. It should be noted that the scale size of each member is accordingly altered so that the member is shown large enough to recognize in the drawings used in the description of the specification.

Here, the printer 1 corresponds to a specific example of the “liquid jet recording device” in the present disclosure, and the inkjet heads 4 (the inkjet heads 4Y, 4M, 4C, and 4B described later) each correspond to a specific example of a “liquid jet head” in the present disclosure. Further, the ink 9 corresponds to a specific example of the “liquid” in the present disclosure.

The carrying mechanisms 2a, 2b are each a mechanism for carrying the recording paper P along the carrying direction d (an X-axis direction) as shown in FIG. 1. These carrying mechanisms 2a, 2b each have a grit roller 21, a pinch roller 22 and a drive mechanism (not shown). The grit roller 21 and the pinch roller 22 are each disposed so as to extend along a Y-axis direction (the width direction of the recording paper P). The drive mechanism is a mechanism for rotating (rotating in a Z-X plane) the grit roller 21 around an axis, and is constituted by, for example, a motor.

### (Ink Tanks 3)

The ink tanks 3 are each a tank for containing the ink 9 inside. As the ink tanks 3, there are disposed 4 types of tanks for individually containing 4 colors of ink 9, namely yellow (Y), magenta (M), cyan (C), and black (B), in this example as shown in FIG. 1. Specifically, there are disposed the ink tank 3Y for containing the yellow ink 9, the ink tank 3M for containing the magenta ink 9, the ink tank 3C for containing the cyan ink 9, and the ink tank 3B for containing the black ink 9. These ink tanks 3Y, 3M, 3C, and 3B are arranged side by side along the X-axis direction inside the housing 10.

It should be noted that the ink tanks 3Y, 3M, 3C, and 3B have the same configuration except the color of the ink 9 contained, and are therefore collectively referred to as ink tanks 3 in the following description. Further, the ink tanks 3 (3Y, 3M, 3C, and 3B) correspond to an example of a “containing section” in the present disclosure.

### (Inkjet Heads 4)

The inkjet heads 4 are each a head for jetting (ejecting) the ink 9 having a droplet shape from a plurality of nozzles (nozzle holes H1, H2) described later to the recording paper P to thereby perform recording of images, characters, and so on. As the inkjet heads 4, there are also disposed 4 types of heads for individually jetting the 4 colors of ink 9 respectively contained by the ink tanks 3Y, 3M, 3C, and 3B described above in this example as shown in FIG. 1. Specifically, there are disposed the inkjet head 4Y for jetting the yellow ink 9, the inkjet head 4M for jetting the magenta ink 9, the inkjet head 4C for jetting the cyan ink 9, and the inkjet head 4B for jetting the black ink 9. These inkjet heads 4Y, 4M, 4C, and 4B are arranged side by side along the Y-axis direction in the housing 10.

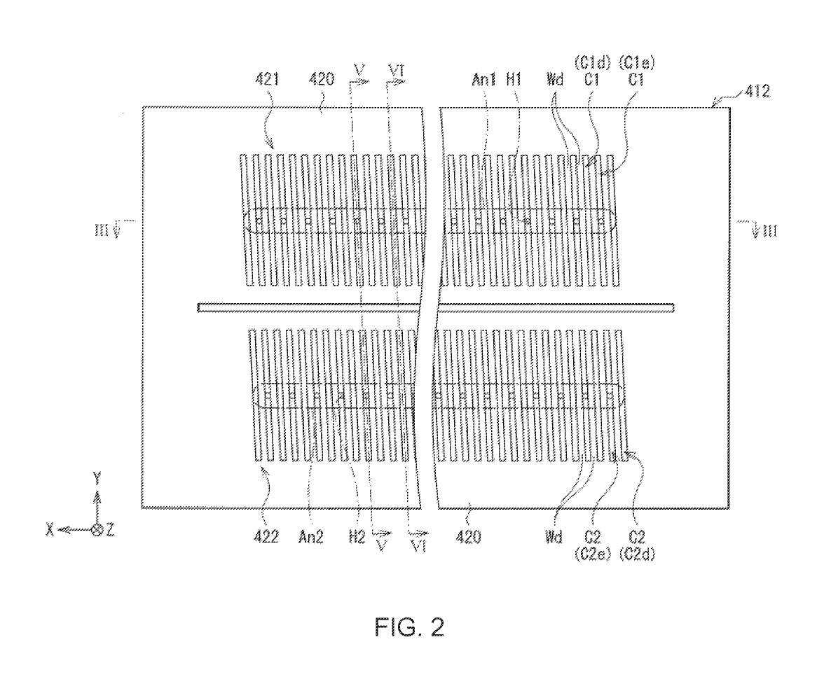

It should be noted that the inkjet heads 4Y, 4M, 4C, and 4B have the same configuration except the color of the ink 9 used, and are therefore collectively referred to as inkjet heads 4 in the following description. Further, the detailed configuration of the inkjet heads 4 will be described later (FIG. 2 through FIG. 6).

### (Circulation Mechanism 5)

The circulation mechanism 5 is a mechanism for circulating the ink 9 between the inside of the ink tanks 3 and the inside of the inkjet heads 4. The circulation mechanism 5 is configured including, for example, circulation channels 50 as flow channels for circulating the ink 9, and pairs of liquid feeding pumps 52a, 52b.

As shown in FIG. 1, the circulation channels 50 each have a flow channel 50a as a part extending from the ink tank 3 to reach the inkjet head 4 via the liquid feeding pump 52a, and a flow channel 50b as a part extending from the inkjet head 4 to reach the ink tank 3 via the liquid feeding pump 52b. In other words, the flow channel 50a is a flow channel through which the ink 9 flows from the ink tank 3 toward the inkjet head 4. Further, the flow channel 50b is a flow channel through which the ink 9 flows from the inkjet head 4 toward the ink tank 3. It should be noted that these flow channels 50a, 50b (supply tubes of the ink 9) are each formed of a flexible hose having flexibility.

### (Scanning Mechanism 6)

The scanning mechanism 6 is a mechanism for making the inkjet heads 4 perform a scanning operation along the width direction (the Y-axis direction) of the recording paper P. As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction. Further, the drive mechanism 63 is provided with a pair of pulleys 631a, 631b disposed between the pair of guide rails 61a, 61b, an endless belt 632 wound between the pair of pulleys 631a, 631b, and a drive motor 633 for rotationally driving the pulley 631a.

The pulleys 631a, 631b are respectively disposed in areas corresponding to the vicinities of both ends in each of the guide rails 61a, 61b along the Y-axis direction. To the endless belt 632, there is connected the carriage 62. On the carriage 62, there are disposed the four types of inkjet heads 4Y, 4M, 4C, and 4B arranged side by side along the Y-axis direction.

It should be noted that it is arranged that a moving mechanism for moving the inkjet heads 4 relatively to the recording paper P is constituted by such a scanning mechanism 6 and the carrying mechanisms 2a, 2b described above.

### [Detailed Configuration of Inkjet Heads 4]

Then, the detailed configuration example of the inkjet heads 4 (head chips 41) will be described with reference to FIG. 2 through FIG. 6, in addition to FIG. 1.

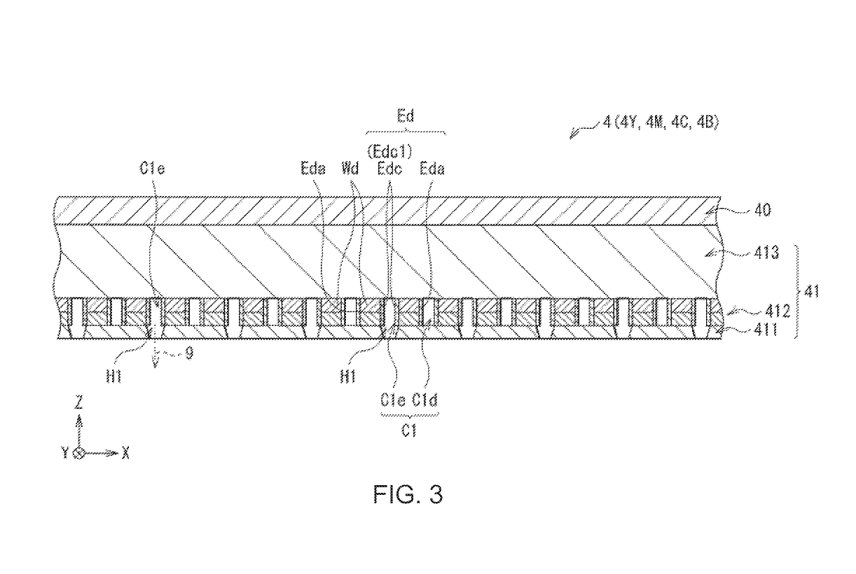

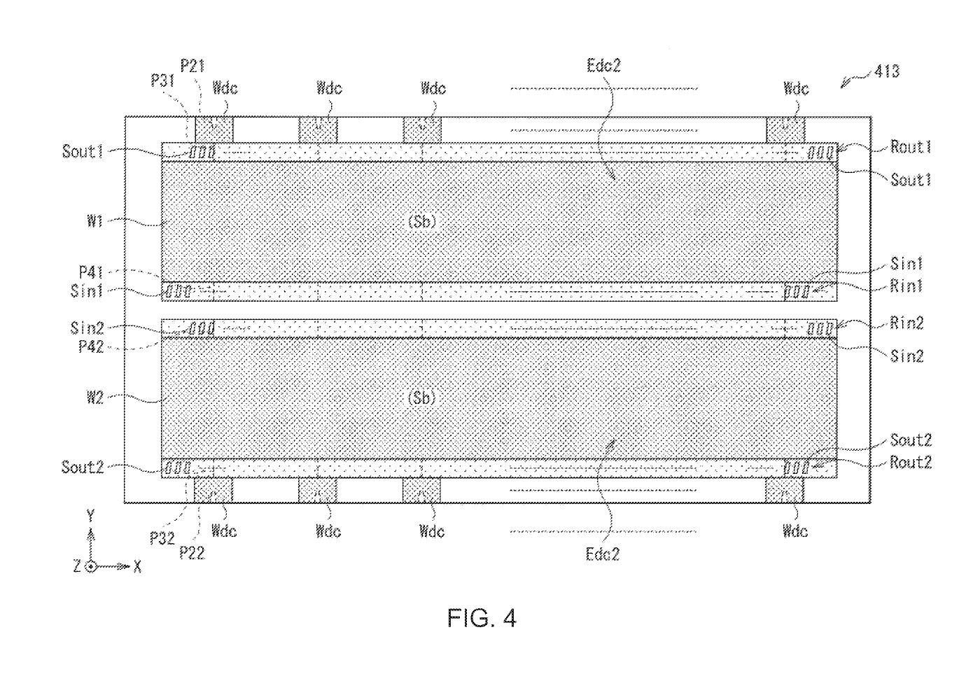

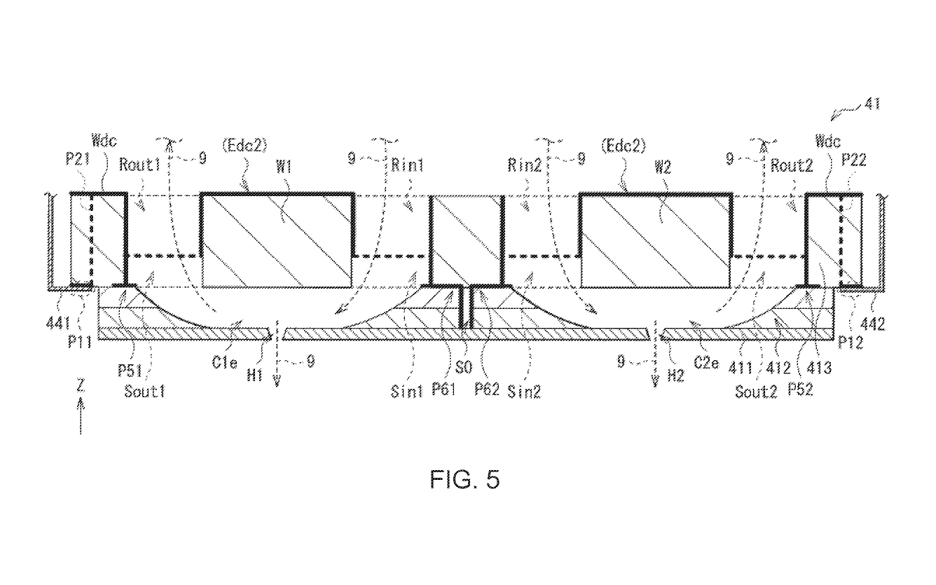

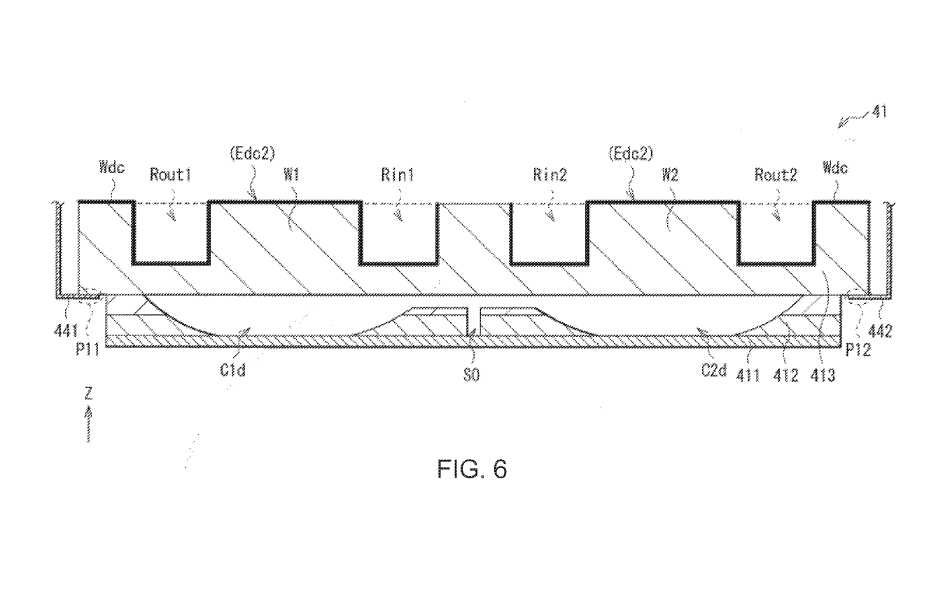

FIG. 2 is a diagram schematically showing a bottom view (an X-Y bottom view) of a configuration example of a substantial part of the inkjet head 4 in the state in which a nozzle plate 411 (described later) is removed. FIG. 3 is a diagram schematically showing a cross-sectional configuration example (a Z-X cross-sectional configuration example) of the inkjet head 4 along the line shown in FIG. 2. FIG. 4 is a diagram schematically showing a top surface configuration example (an X-Y top surface configuration example) of a cover plate 413 (described later) shown in FIG. 3. FIG. 5 is a diagram schematically showing a cross-sectional configuration example of the inkjet head 4 along the line V-V shown in FIG. 2, and corresponds to a cross-sectional configuration example of a vicinity of ejection channels C1e, C2e (ejection grooves) in the head chip 41 described later. Further, FIG. 6 is a diagram schematically showing a cross-sectional configuration example of the inkjet head 4 along the line VI-VI shown in FIG. 2, and corresponds to a cross-sectional configuration example of a vicinity of dummy channels C1d, C2d (non-ejection grooves) in the head chip 41 described later.

The inkjet heads 4 according to the present embodiment are each an inkjet head of a so-called side-shoot type for ejecting the ink 9 from a central part in an extending direction (an oblique direction described later) of a plurality of channels (a plurality of channels C1 and a plurality of channels C2) in the head chip 41 described later. Further, the inkjet heads 4 are each an inkjet head of a circulation type which uses the circulation mechanism 5 (the circulation channel 50) described above to thereby use the ink 9 while circulated between the inkjet head 4 and the ink tank 3.

As shown in FIG. 3, the inkjet heads 4 are each provided with the head chip 41 and a flow channel plate 40. Further, the inkjet heads 4 are each provided with a circuit board (not shown) and flexible printed circuit boards (FPC) 441, 442 described later as a control mechanism (a mechanism for controlling the operation of the head chip 41).

The circuit board is a board for mounting a drive circuit (an electric circuit) for driving the head chip 41. Although the details will be described later (see FIG. 4 and FIG. 5), the flexible printed circuit boards 441, 442 are each a board for providing electrical connections between the drive circuit on the circuit board and drive electrodes Ed described later in the head chip 41. It should be noted that it is arranged that such flexible printed circuit boards 441, 442 are each provided with a plurality of extraction electrodes described later as printed wiring.

As shown in FIG. 3, the head chip 41 is a member for jetting the ink 9 along the Z-axis direction, and is configured using a variety of types of plates. Specifically, as shown in FIG. 3, the head chip 41 is mainly provided with a nozzle plate (a jet hole plate) 411, an actuator plate 412 and a cover plate 413. The nozzle plate 411, the actuator plate 412, the cover plate 413, and the flow channel plate 40 described above are bonded to each other using, for example, an adhesive, and are stacked on one another in this order along the Z-axis direction. It should be noted that the description will hereinafter be presented with the flow channel plate 40 side (the cover plate 413 side) along the Z-axis direction referred to as an upper side, and the nozzle plate 411 side referred to as a lower side.

### (Nozzle Plate 411)

The nozzle plate 411 is formed of a film member made of polyimide or the like having a thickness of, for example, about 50 μm, and is bonded to a lower surface of the actuator plate 412 as shown in FIG. 3. It should be noted that the constituent material of the nozzle plate 411 is not limited to the resin material such as polyimide, but can also be, for example, a metal material. Further, as shown in FIG. 2, the nozzle plate 411 is provided with two nozzle columns (nozzle columns An1, An2) each extending along the X-axis direction. These nozzle columns An1, An2 are arranged along the Y-axis direction with a predetermined distance. As described above, the inkjet head 4 (the head chip 41) of the present embodiment is formed as a two-column type inkjet head (head chip).

The nozzle column An1 has a plurality of nozzle holes H1 formed so as to be arranged in a straight line at predetermined intervals along the X-axis direction. These nozzle holes H1 each penetrate the nozzle plate 411 along the thickness direction of the nozzle plate 411 (the Z-axis direction), and are communicated with the respective ejection channels C1e in the actuator plate 412 described later as shown in, for example, FIG. 3 and FIG. 5. Specifically, as shown in FIG. 2, each of the nozzle holes H1 is formed so as to be located in a central part along the extending direction (an oblique direction described later) of the ejection channels C1e. Further, the formation pitch along the X-axis direction in the nozzle holes H1 is arranged to be equal (to have an equal pitch) to the formation pitch along the X-axis direction in the ejection channels C1e. Although the details will be described later, it is arranged that the ink 9 supplied from the inside of the ejection channel C1e is ejected (jetted) from each of the nozzle holes H1 of such a nozzle column An1.

The nozzle column An2 similarly has a plurality of nozzle holes H2 formed so as to be arranged in a straight line at predetermined intervals along the X-axis direction. These nozzle holes H2 each penetrate the nozzle plate 411 along the thickness direction of the nozzle plate 411, and are communicated with the respective ejection channels C2e in the actuator plate 412 described later. Specifically, as shown in FIG. 2, each of the nozzle holes H2 is formed so as to be located in a central part along the extending direction (an oblique direction described later) of the ejection channels C2e. Further, the formation pitch along the X-axis direction in the nozzle holes H2 is arranged to be equal to the formation pitch along the X-axis direction in the ejection channels C2e. Although the details will be described later, it is arranged that the ink 9 supplied from the inside of the ejection channel C2e is also ejected from each of the nozzle holes H2 of such a nozzle column An2.

Further, as shown in FIG. 2, the nozzle holes H1 in the nozzle column An1 and the nozzle holes H2 in the nozzle column An2 are arranged in a staggered manner along the X-axis direction. Therefore, in each of the inkjet heads 4 according to the present embodiment, the nozzle holes H1 in the nozzle column An1 and the nozzle holes H2 in the nozzle column An2 are arranged in a zigzag manner. It should be noted that such nozzle holes H1, H2 each have a tapered through hole gradually decreasing in diameter toward the lower side.

### (Actuator Plate 412)

The actuator plate 412 is a plate formed of a piezoelectric material such as lead zirconate titanate (PZT). As shown in FIG. 3, the actuator plate 412 is formed by stacking two piezoelectric substrates different in polarization direction from each other on one another along the thickness direction (the Z-axis direction) (a so-called chevron type). It should be noted that the configuration of the actuator plate 412 is not limited to the chevron type. Specifically, it is also possible to form the actuator plate 412 with, for example, a single (unique) piezoelectric substrate having the polarization direction set one direction along the thickness direction (the Z-axis direction) (a so-called cantilever type).

Further, as shown in FIG. 2, the actuator plate 412 is provided with two channel columns (channel columns 421, 422) each extending along the X-axis direction. These channel columns 421, 422 are arranged along the Y-axis direction with a predetermined distance.

In such an actuator plate 412, as shown in FIG. 2, an ejection area (jetting area) of the ink 9 is disposed in a central part (the formation areas of the channel columns 421, 422) along the X-axis direction. On the other hand, in the actuator plate 412, a non-ejection area (non-jetting area) of the ink 9 is disposed in each of the both end parts (non-formation areas of the channel columns 421, 422) along the X-axis direction. The non-ejection areas are located on the outer side along the X-axis direction with respect to the ejection area described above. It should be noted that the both end parts along the Y-axis direction in the actuator plate 412 each constitute a tail part 420 as shown in FIG. 2.

As shown in FIG. 2 and FIG. 3, the channel column 421 described above has a plurality of channels C1. As shown in FIG. 2, these channels C1 extend along an oblique direction forming a predetermined angle (an acute angle) with the Y-axis direction inside the actuator plate 412. Further, as shown in FIG. 2, these channels C1 are arranged side by side so as to be parallel to each other at predetermined intervals along the X-axis direction. Each of the channels C1 is partitioned with drive walls Wd formed of a piezoelectric body (the actuator plate 412), and forms a groove section having a recessed shape in a cross-sectional view (see FIG. 3).

As shown in FIG. 2, the channel column 422 similarly has a plurality of channels C2 extending along the oblique direction described above. As shown in FIG. 2, these channels C2 are arranged side by side so as to be parallel to each other at predetermined intervals along the X-axis direction. Each of the channels C2 is also partitioned with drive walls Wd described above, and forms a groove section having a recessed shape in a cross-sectional view.

Here, as shown in FIG. 2, FIG. 3, FIG. 5, and FIG. 6, in the channels C1, there exist ejection channels C1e (ejection grooves) for ejecting the ink 9, and dummy channels C1d (non-ejection grooves) not ejecting the ink 9. As shown in FIG. 2 and FIG. 3, in the channel column 421, the ejection channels C1e and the dummy channels C1d are alternately arranged along the X-axis direction. Further, each of the ejection channels C1e is communicated with the nozzle hole H1 in the nozzle plate 411 on the one hand, but each of the dummy channels C1d is not communicated with the nozzle hole H1, and is covered with an upper surface of the cover plate 411 from below on the other hand (see FIG. 3, FIG. 5 and FIG. 6).

Similarly, as shown in FIG. 2, FIG. 5 and FIG. 6, in the channels C2, there exist ejection channels C2e (ejection grooves) for ejecting the ink 9, and dummy channels C2d (non-ejection grooves) not ejecting the ink 9. As shown in FIG. 2, in the channel column 422, the ejection channels C2e and the dummy channels C2d are alternately arranged along the X-axis direction. Further, each of the ejection channels C2e is communicated with the nozzle hole H2 in the nozzle plate 411 on the one hand, but each of the dummy channels C2d is not communicated with the nozzle hole H2, and is covered with the upper surface of the cover plate 411 from below on the other hand (see FIG. 5 and FIG. 6).

It should be noted that such ejection channels C1e, C2e each correspond to one specific example of the “ejection groove” in the present disclosure.

Further, as indicated by the line V-V in FIG. 2, the ejection channels C1e in the channel column 421 and the ejection channel C2e in the channel column 422 are disposed in alignment with each other (see FIG. 5) along the extending direction (the oblique direction described above) of these ejection channels C1e, C2e. Similarly, as indicated by the line VI-VI in FIG. 2, the dummy channels C1d in the channel column 421 and the dummy channel C2d in the channel column 422 are disposed in alignment with each other (see FIG. 6) along the extending direction (the oblique direction described above) of these dummy channels C1d, C2d.

It should be noted that as shown in FIG. 5, the ejection channels C1e, C2e each have arc-like side surfaces with which the cross-sectional area of each of the ejection channels C1e, C2e gradually decreases in a direction from the cover plate 413 side (upper side) toward the nozzle plate 411 side (lower side). It is arranged that the arc-like side surfaces of such ejection channels C1e, C2e are each formed by, for example, cutting work using a dicer.

Here, as shown in FIG. 3, the drive electrode Ed extending along the oblique direction described above is disposed on each of the inside surfaces opposed to each other in the drive walls Wd described above. As the drive electrodes Ed, there exist common electrodes Edc (Edc1) disposed on the inner side surfaces facing the ejection channels C1e, C2e, and individual electrodes (active electrodes) Eda disposed on the inner side surfaces facing the dummy channels C1d, C2d. It should be noted that such drive electrodes Ed (the common electrodes Edc1 and the active electrodes Eda) are each formed in the entire area in the depth direction (the Z-axis direction) on the inner side surface of the drive wall Wd as shown in FIG. 3.

The pair of common electrodes Edc1 opposed to each other in the same ejection channel C1e (or the same ejection channel C2e) are electrically connected to each other in a common terminal (a common interconnection Wdc described later). Further, the pair of individual electrodes Eda opposed to each other in the same dummy channel C1d (or the same dummy channel C2d) are electrically separated from each other. In contrast, the pair of individual electrodes Eda opposed to each other via the ejection channel C1e (or the ejection channel C2e) are electrically connected to each other in an individual terminal (an individual interconnection) not shown.

Here, in the tail parts 420 described above, there are mounted the flexible printed circuit boards 441, 442 described above for electrically connecting the drive electrodes Ed and the circuit board described above to each other. Although the details will be described later (see FIG. 4 through FIG. 6), the interconnection patterns (not shown) formed in these flexible printed circuit boards 441, 442 are electrically connected to the common interconnections Wdc and the individual interconnections described above. Thus, it is arranged that the drive voltage is applied to each of the drive electrodes Ed from the drive circuit on the circuit board described above via these flexible printed circuit boards 441, 442.

### (Cover Plate 413)

As shown in FIG. 3, FIG. 5 and FIG. 6, the cover plate 413 is disposed so as to close the channels C1, C2 (the channel columns 421, 422) in the actuator plate 412. Specifically, the cover plate 413 is bonded to the upper surface of the actuator plate 412, and has a plate-like structure.

As shown in FIG. 4 through FIG. 6, the cover plate 413 is provided with a pair of entrance side common ink chambers Rin1, Rin2 and a pair of exit side common ink chambers Rout1, Rout2. The entrance side common ink chambers Rin1, Rin2 and the exit side common ink chambers Rout1, Rout2 each extend along the X-axis direction, and are arranged side by side so as to be parallel to each other at predetermined intervals. Further, the entrance side common ink chamber Rin1 and the exit side common ink chamber Rout1 are each formed in an area corresponding to the channel column 421 (the plurality of channels C1) in the actuator plate 412. Meanwhile, the entrance side common ink chamber Rin2 and the exit side common ink chamber Rout2 are each formed in an area corresponding to the channel column 422 (the plurality of channels C2) in the actuator plate 412.

The entrance side common ink chamber Rin1 is formed in the vicinity of an inner end part along the Y-axis direction in the channels C1, and forms a groove section having a recessed shape (see FIG. 4 through FIG. 6). In areas corresponding respectively to the ejection channels C1e in the entrance side common ink chamber Rin1, there are respectively formed supply slits Sin1 penetrating the cover plate 413 along the thickness direction (the Z-axis direction) of the cover plate 413 (see FIG. 5). Similarly, the entrance side common ink chamber Rin2 is formed in the vicinity of an inner end part along the Y-axis direction in the channels C2, and forms a groove section having a recessed shape (see FIG. 4 through FIG. 6). In areas corresponding respectively to the ejection channels C2e in the entrance side common ink chamber Rin2, there are respectively formed supply slits Sin2 penetrating the cover plate 413 along the thickness direction of the cover plate 413 (see FIG. 5).

It should be noted that these entrance side common ink chambers Rin1, Rin2 each correspond to a specific example of a “first groove section” in the present disclosure. Further, the supply slits Sin1, Sin2 each correspond to a specific example of a “first through hole” in the present disclosure.

The exit side common ink chamber Rout1 is formed in the vicinity of an outer end part along the Y-axis direction in the channels C1, and forms a groove section having a recessed shape (see FIG. 4 through FIG. 6). In areas corresponding respectively to the ejection channels C1e in the exit side common ink chamber Rout1, there are respectively formed discharge slits Sout1 penetrating the cover plate 413 along the thickness direction of the cover plate 413 (see FIG. 5). Similarly, the exit side common ink chamber Rout2 is formed in the vicinity of an outer end part along the Y-axis direction in the channels C2, and forms a groove section having a recessed shape (see FIG. 4 through FIG. 6). In areas corresponding respectively to the ejection channels C2e in the exit side common ink chamber Rout2, there are also respectively formed discharge slits Sout2 penetrating the cover plate 413 along the thickness direction of the cover plate 413 (see FIG. 5).

It should be noted that these exit side common ink chambers Rout1, Rout2 each correspond to a specific example of a “second groove section” in the present disclosure. Further, the discharge slits Sout1, Sout2 each correspond to a specific example of a “second through hole” in the present disclosure.

In such a manner, the entrance side common ink chamber Rin1 and the exit side common ink chamber Rout1 are communicated with each of the ejection channels C1e via the supply slit Sin1 and the discharge slit Sout1 on the one hand, but are not communicated with each of the dummy channels C1d on the other hand (see FIG. 5 and FIG. 6). In other words, it is arranged that each of the dummy channels C1d is closed by a bottom part of the entrance side common ink chamber Rin1 and a bottom part of the exit side common ink chamber Rout1 (see FIG. 6).

Similarly, the entrance side common ink chamber Rin2 and the exit side common ink chamber Rout2 are communicated with each of the ejection channels C2e via the supply slit Sin2 and the discharge slit Sout2 on the one hand, but are not communicated with each of the dummy channels C2d on the other hand (see FIG. 5 and FIG. 6). In other words, it is arranged that each of the dummy channels C2d is closed by a bottom part of the entrance side common ink chamber Rin2 and a bottom part of the exit side common ink chamber Rout2 (see FIG. 6).

### (Flow Channel Plate 40)

As shown in FIG. 3, the flow channel plate 40 is disposed on the upper surface of the cover plate 413, and has a predetermined flow channel (not shown) through which the ink 9 flows. Further, to the flow channel in such a flow channel plate 40, there are connected the flow channels 50a, 50b in the circulation mechanism 5 described above so as to achieve inflow of the ink 9 to the flow channel and outflow of the ink 9 from the flow channel, respectively.

### [Configuration of Common Interconnections Wdc, Common Electrodes Edc2]

Then, the common interconnections Wdc (the interconnections electrically connected to the common electrodes Edc1 formed inside each of the ejection channels C1e, C2e) described above, and the common electrodes Edc2 formed by electrically connecting the plurality of common interconnections Wdc to each other will be described in detail with reference to FIG. 4 through FIG. 6.

Firstly, as shown in FIG. 4, the cover plate 413 of the present embodiment is provided with the supply slits Sin1, Sin2 and the discharge slits Sout1, Sout2 described above, and wall parts W1, W2. Specifically, the supply slits Sin1 and the discharge slits Sout1 are each a through hole through which the ink 9 flows to or from the ejection channel C1e, and the supply slits Sin2 and the discharge slits Sout2 are each a through hole through which the ink 9 flows to or from the ejection channel C2e. In detail, as indicated by the dotted arrows in FIG. 5, the supply slits Sin1, Sin2 are through holes for making the ink 9 inflow into the ejection channels C1e, C2e, respectively, and the discharge slits Sout1, Sout2 are through holes for making the ink 9 outflow from the inside of the ejection channels C1e, C2e, respectively.

Further, the wall part W1 described above is disposed between the entrance side common ink chamber Rin1 and the exit side common ink chamber Rout1 so as to cover above the ejection channels C1e. Similarly, the wall part W2 described above is disposed between the entrance side common ink chamber Rin2 and the exit side common ink chamber Rout2 so as to cover above the ejection channels C2e.

Here, in the head chip 41 of the present embodiment, firstly, the common electrodes Edc1 respectively formed in the plurality of ejection channels C1e are electrically connected to each other (see the reference symbol P51 in FIG. 5), and are extracted to the upper surface of the cover plate 413 as the common interconnections Wdc described above (see FIG. 4 through FIG. 6). The common interconnections Wdc are electrically connected to extraction electrodes on the flexible printed circuit board 441 described above on the bottom surface of the cover plate 413 via the through holes or the cutout parts (see the reference symbol P21 in FIG. 4 and FIG. 5) penetrating the cover plate 413 (see the reference symbol P11 in FIG. 5). Further, the common interconnections Wdc described above are also extracted inside the exit side common ink chamber Rout1 (see the reference symbol P31 in FIG. 4, and FIG. 5 and FIG. 6).

Similarly, in the head chip 41, the common electrodes Edc1 respectively formed in the plurality of ejection channels C2e are electrically connected to each other (see the reference symbol P52 in FIG. 5), and are extracted to the upper surface of the cover plate 413 as the common interconnections Wdc (see FIG. 4 through FIG. 6). The common interconnections Wdc are electrically connected to extraction electrodes on the flexible printed circuit board 442 described above on the bottom surface of the cover plate 413 via the through holes or the cutout parts (see the reference symbol P22 in FIG. 4 and FIG. 5) penetrating the cover plate 413 (see the reference symbol P12 in FIG. 5). Further, the common interconnections Wdc described above are also extracted inside the exit side common ink chamber Rout2 (see the reference symbol P32 in FIG. 4, and FIG. 5 and FIG. 6).

Further, in the head chip 41, the common electrodes Edc1 inside the plurality of ejection channels C1e are also electrically connected to each other in the vicinity (on the bottom surface of the cover plate 413; see the reference symbol P61 in FIG. 5) of a groove section S0 formed between the ejection channels C1, C2e and extending in the X-axis direction, and are extracted as the common interconnections Wdc (see FIG. 5). The common interconnections Wdc are extracted inside the entrance side common ink chamber Rin1 from the vicinity of such a groove section S0 (see the reference symbol P41 in FIG. 4, and FIG. 5 and FIG. 6).

Similarly, in the head chip 41, the common electrodes Edc1 inside the plurality of ejection channels C2e are also electrically connected to each other in the vicinity (on the bottom surface of the cover plate 413; see the reference symbol P62 in FIG. 5) of the groove section S0 described above, and are extracted as the common interconnections Wdc (see FIG. 4). The common interconnections Wdc are extracted inside the entrance side common ink chamber Rin2 from the vicinity of such a groove section S0 (see the reference symbol P42 in FIG. 4, and FIG. 5 and FIG. 6). It should be noted that in the vicinity of the groove section S0, the common interconnections Wdc electrically connected to the common electrodes Edc inside the ejection channels C1e and the common interconnections Wdc electrically connected to the common electrodes Edc inside the ejection channels C2e are arranged not to be electrically connected to each other in this example.

Here, in the head chip 41 of the present embodiment, such a plurality of common interconnections Wdc is laid around on the upper surface (a surface on the opposite side to the actuator plate 412, a surface on the flow channel plate 40) of each of the wall parts W1, W2 described above in the cover plate 413 (see FIG. 5 and FIG. 6). It should be noted that the upper surface of each of the wall parts W1, W2 corresponds to a bonding surface Sb with the flow channel plate 40 shown in FIG. 4. Further, at least two or more of such a plurality of common interconnections Wdc are electrically connected to each other on the upper surface (the bonding surface Sb) of each of the wall parts W1, W2 to thereby form the common electrode Edc2 on the bonding surface Sb (see FIG. 4 through FIG. 6).

Specifically, in the present embodiment, the common electrodes Edc2 are formed in the entire areas corresponding to the formation areas of the ejection channels C1e, C2e on the bonding surfaces Sb, respectively (see FIG. 4). It should be noted that the entire area corresponding to the formation area of the ejection channels C1e corresponds to an area between the entrance side common ink chamber Rin1 and the exit side common ink chamber Rout1, and the entire area corresponding to the formation area of the ejection channels C2e corresponds to an area between the entrance side common ink chamber Rin2 and the exit side common ink chamber Rout2 (see FIG. 4).

In other words, firstly, the common electrode Edc2 is formed on the bonding surface Sb by electrically connecting at least two or more (all in this example) of the common interconnections Wdc arranged side by side along the X-axis direction to each other. Specifically, in this example, as shown in FIG. 4, all of the common interconnections Wdc indicated by the reference symbol P31 are electrically connected to each other. Similarly, in this example, all of the common interconnections Wdc indicated by the reference symbol P32 are electrically connected to each other, all of the common interconnections Wdc indicated by the reference symbol P41 are electrically connected to each other, and all of the common interconnections Wdc indicated by the reference symbol P42 are electrically connected to each other.

Further, the common interconnections Wdc (see the reference symbol P41 in FIG. 4) laid around from the inside of the entrance side common ink chamber Rin1 and the common interconnections Wdc (see the reference symbol P31 in FIG. 4) laid around from the inside of the exit side common ink chamber Rout1 are electrically connected to each other on the bonding surface Sb along the Y-axis direction to thereby form the common electrode Edc2 (see FIG. 4 through FIG. 6). Similarly, the common interconnections Wdc (see the reference symbol P42 in FIG. 4) laid around from the inside of the entrance side common ink chamber Rin2 and the common interconnections Wdc (see the reference symbol P32 in FIG. 4) laid around from the inside of the exit side common ink chamber Rout2 are electrically connected to each other on the bonding surface Sb along the Y-axis direction to thereby form the common electrode Edc2 (see FIG. 4 through FIG. 6).

Here, the common electrode Edc1 corresponds to a specific example of a “first common electrode” in the present disclosure, and the common electrode Edc2 corresponds to a specific example of a “second common electrode” in the present disclosure. Further, the X-axis direction corresponds to a specific example of a “first direction” in the present disclosure, and the Y-axis direction corresponds to a specific example of a “second direction (a direction crossing the first direction)” in the present disclosure. Further, the bonding surface Sb corresponds to a specific example of a “surface on an opposite side (to the actuator plate in the wall part)” in the present disclosure.

### [Operations and Functions/Advantages]

### (A. Basic Operation of Printer 1)

In the printer 1, a recording operation (a printing operation) of images, characters, and so on to the recording paper P is performed in the following manner. It should be noted that as an initial state, it is assumed that the four types of ink tanks 3 (3Y, 3M, 3C, and 3B) shown in FIG. 1 are sufficiently filled with the ink 9 of the corresponding colors (the four colors), respectively. Further, there is achieved the state in which the inkjet heads 4 are filled with the ink 9 in the ink tanks 3 via the circulation mechanism 5, respectively.

In such an initial state, when operating the printer 1, the grit rollers 21 in the carrying mechanisms 2a, 2b rotate to thereby carry the recording paper P along the carrying direction d (the X-axis direction) between the grit rollers 21 and the pinch rollers 22. Further, at the same time as such a carrying operation, the drive motor 633 in the drive mechanism 63 respectively rotates the pulleys 631a, 631b to thereby operate the endless belt 632. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4B) to thereby perform the recording operation of images, characters, and so on to the recording paper P.

### (B. Detailed Operation in Inkjet Heads 4)

Then, the detailed operation (the jet operation of the ink 9) in the inkjet heads 4 will be described with reference to FIG. 1 through FIG. 6. Specifically, in the inkjet heads 4 (the side-shoot type) according to the present embodiment, the jet operation of the ink 9 using a shear mode is performed in the following manner.

Firstly, when the reciprocation of the carriage 62 (see FIG. 1) described above is started, the drive circuit on the circuit board described above applies the drive voltage to the drive electrodes Ed (the common electrodes Edc1 and the individual electrodes Eda) in the inkjet head 4 (the head chip 41) via the flexible printed circuit boards 441, 442. Specifically, the drive circuit applies the drive voltage to the drive electrodes Ed disposed on the pair of drive walls Wd forming the ejection channel C1e, C2e. Thus, the pair of drive walls Wd each deform (see FIG. 3) so as to protrude toward the dummy channel C1d, C2d adjacent to the ejection channel C1e, C2e.

Here, as described above, in the actuator plate 412, the polarization direction differs along the thickness direction (the two piezoelectric substrates described above are stacked on one another), and at the same time, the drive electrodes Ed are formed in the entire area in the depth direction on the inner side surface in each of the drive walls Wd. Therefore, by applying the drive voltage using the drive circuit described above, it results that the drive wall Wd makes a flexion deformation to have a V shape centered on the intermediate position in the depth direction in the drive wall Wd. Further, due to such a flexion deformation of the drive wall Wd, the ejection channel C1e, C2e deforms as if the ejection channel C1e, C2e bulges. Incidentally, in the case in which the configuration of the actuator plate 412 is not the chevron type but is the cantilever type described above, the drive wall Wd makes the flexion deformation to have the V shape in the following manner. That is, in the case of the cantilever type, since it results that the drive electrode Ed is attached by the oblique evaporation to an upper half in the depth direction, by the drive force exerted only on the part provided with the drive electrode Ed, the drive wall Wd makes the flexion deformation (in the end part in the depth direction of the drive electrode Ed). As a result, even in this case, since the drive wall Wd makes the flexion deformation to have the V shape, it results that the ejection channel C1e, C2e deforms as if the ejection channel C1e, C2e bulges.

As described above, due to the flexion deformation caused by a piezoelectric thickness-shear effect in the pair of drive walls Wd, the capacity of the ejection channel C1e, C2e increases. Further, due to the increase of the capacity of the ejection channel C1e, C2e, it results that the ink 9 retained in the entrance side common ink chamber Rin1, Rin2 is induced into the ejection channel C1e, C2e (see FIG. 5).

Subsequently, the ink 9 having been induced into the ejection channel C1e, C2e in such a manner turns to a pressure wave to propagate to the inside of the ejection channel C1e, C2e. Then, the drive voltage to be applied to the drive electrodes Ed becomes 0 (zero) V at the timing at which the pressure wave has reached the nozzle hole H1, H2 of the nozzle plate 411. Thus, the drive walls Wd are restored from the state of the flexion deformation described above, and as a result, the capacity of the ejection channel C1e, C2e having once increased is restored again (see FIG. 3).

When the capacity of the ejection channel C1e, C2e is restored in such a manner, the internal pressure of the ejection channel C1e, C2e increases, and the ink 9 in the ejection channel C1e, C2e is pressurized. As a result, the ink 9 having a droplet shape is ejected (see FIG. 3 and FIG. 5) toward the outside (toward the recording paper P) through the nozzle hole H1, H2. The jet operation (the ejection operation) of the ink 9 in the inkjet head 4 is performed in such a manner, and as a result, the recording operation of images, characters, and so on to the recording paper P is performed.

In particular, the nozzle holes H1, H2 of the present embodiment each have the tapered cross-sectional shape gradually decreasing in diameter toward the outlet (see FIG. 3 and FIG. 5) as described above, and can therefore eject the ink 9 straight (good in straightness) at high speed. Therefore, it becomes possible to perform recording high in image quality.

### (C. Circulation Operation of Ink 9)

Then, the circulation operation of the ink 9 by the circulation mechanism 5 will be described in detail with reference to FIG. 1 and FIG. 5.

As shown in FIG. 1, in the printer 1, the ink 9 is fed by the liquid feeding pump 52a from the inside of the ink tank 3 to the inside of the flow channel 50a. Further, the ink 9 flowing through the flow channel 50b is fed by the liquid feeding pump 52b to the inside of the ink tanks 3.

On this occasion, in the inkjet head 4, the ink 9 flowing from the inside of the ink tank 3 via the flow channel 50a inflows into the entrance side common ink chambers Rin1, Rin2. As shown in FIG. 5, the ink 9 having been supplied to these entrance side common ink chambers Rin1, Rin2 is supplied to the ejection channels C1e, C2e in the actuator plate 412 via the supply slits Sin1, Sin2.

Further, as shown in FIG. 5, the ink 9 in the ejection channels C1e, C2e flows into the exit side common ink chambers Rout1, Rout2 via the discharge slits Sout1, Sout2, respectively. The ink 9 having been supplied to these exit side common ink chambers Rout1, Rout2 is discharged to the flow channel 50b to thereby outflow from the inkjet head 4. Then, the ink 9 having been discharged to the flow channel 50b is returned to the inside of the ink tank 3 as a result. In such a manner, the circulation operation of the ink 9 by the circulation mechanism 5 is achieved.

Here, in the inkjet head which is not the circulation type, in the case in which ink of a fast drying type is used, there is a possibility that a local increase in viscosity or local solidification of the ink occurs due to drying of the ink in the vicinity of the nozzle hole, and as a result, a failure such as a failure in ejection of the ink occurs. In contrast, in the inkjet heads 4 (the circulation type inkjet heads) according to the present embodiment, since the fresh ink 9 is always supplied to the vicinity of the nozzle holes H1, H2, the failure such as the failure in ejection of the ink described above is prevented as a result.

### (D. Functions/Advantages)

Then, the functions and the advantages in the head chip 41, the inkjet head 4 and the printer 1 according to the present embodiment will be described in detail while comparing with a comparative example.

### Comparative Example

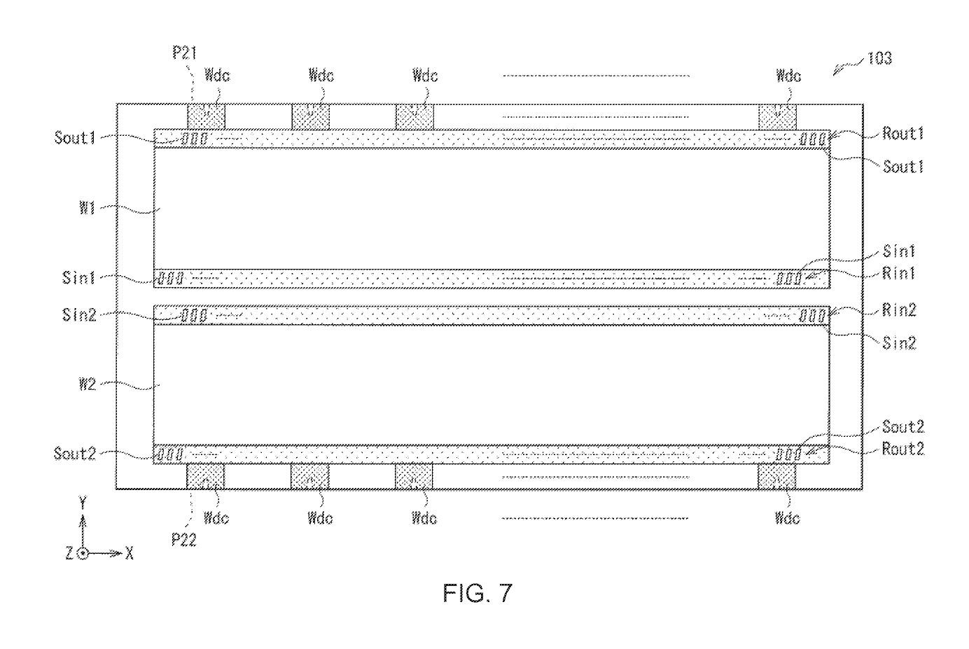

FIG. 7 is a diagram schematically showing a top surface configuration example (an X-Y top surface configuration example) of a cover plate (a cover plate 103) in a head chip related to a comparative example. The cover plate 103 of the comparative example corresponds to what is arranged not to form the common electrodes Edc2 described above in the cover plate 413 of the present embodiment shown in FIG. 4. In other words, in the cover plate 103 of the comparative example, as shown in FIG. 7, the electrical connection between at least two or more common interconnections Wdc is not made on the upper surface (the bonding surface Sb) of each of the wall parts W1, W2.

In the cover plate 103 of such a comparative example, since the interconnection resistance in the common interconnections Wdc increases, there is a possibility that, for example, blunting of a signal waveform in the drive voltage applied to the common interconnections Wdc or heat generation in the common interconnections Wdc occurs. Further, depending on the formation position along the X-axis direction (the direction in which the ejection channels C1e, C2e are arranged side by side) of the ejection channels C1e, C2e, there is a possibility that the variation in the interconnection resistance increases between the common interconnections Wdc laid around from the common electrodes Edc1 inside the ejection channels C1e, C2e. Therefore, there is a possibility that the ejection speed of the ink 9 differs between the ejection channels C1e and between the ejection channels C2e, and thus, the ejection performance in the head chip degrades. Further, in the place where the distance between the flexible printed circuit boards 441, 442 and the common electrodes Edc1 in the ejection channels C1e, C2e is long, since the interconnection resistance of the common interconnections Wdc becomes high, there is a possibility that unwanted heat generation is caused. Further, in that case, there is a possibility that the durability of the head chip deteriorates, and the power consumption increases. Due to these circumstances, in the head chip of this comparative example, there is a possibility that the reliability is damaged.

### Present Embodiment

In contrast, in the head chip 41 of the present embodiment, as shown in FIG. 4 through FIG. 6, firstly, the plurality of common interconnections Wdc electrically connected to the common electrodes Edc1 is laid around on the bonding surface Sb in each of the wall parts W1, W2 of the cover plate 413. Further, at least two or more of such a plurality of common interconnections Wdc are electrically connected to each other on the bonding surface Sb of each of the wall parts W1, W2 to thereby form a single common electrode Edc2 or a plurality of the common electrodes Edc2 (the single common electrode Edc2 in this example) on the bonding surface Sb.

Since such a common electrode Edc2 is formed on the bonding surface Sb of the cover plate 413, the interconnection resistance in the common interconnections Wdc decreases in the head chip 41 of the present embodiment compared to the head chip of the comparative example described above. Therefore, in the present embodiment, it is possible to suppress, for example, blunting of the signal waveform in the drive voltage applied to the common interconnections Wdc and the heat generation in the common interconnections Wdc can be suppressed compared to the comparative example described above. Further, in the present embodiment, such a variation in the interconnection resistance of the common interconnections between the formation position along the X-axis direction of each of the ejection channels C1e, C2e as described above can also be suppressed compared to the comparative example described above. Therefore, the variation in the ejection speed of the ink 9 is suppressed between the ejection channels C1e and between the ejection channels C2e, and thus, the ejection performance in the head chip 41 is improved compared to the comparative example described above. Further, in the place where the distance between the flexible printed circuit boards 441, 442 and the common electrodes Edc1 in the ejection channels C1e, C2e is long, since the interconnection resistance of the common interconnections Wdc becomes low, it becomes easy to prevent the unwanted heat generation from occurring compared to the comparative example described above. Further, as a result, the durability of the head chip 41 is improved, and at the same time, the power consumption decreases. Due to these circumstances, it becomes possible to enhance the reliability of the head chip 41 in the present embodiment compared to the comparative example described above.

Further, in particular in the present embodiment, since the common electrodes Edc2 are formed in the entire areas corresponding to the formation areas of the ejection channels C1e, C2e on the bonding surfaces Sb, respectively, as shown in FIG. 4, the interconnection resistance in the common interconnections Wdc is decreased to the lowest as a result. Therefore, it is possible to further suppress, for example, such blunting of the signal waveform in the drive voltage applied to the common interconnections Wdc, heat generation in the common interconnections Wdc, and a variation in the interconnection resistance of the common interconnections between the formation positions along the X-axis direction of the ejection channels C1e, C2e as described above. Further, for example, as described above, since the variation in the ejection speed of the ink 9 is further suppressed between the ejection channels C1e and between the ejection channels C2e, the ejection performance in the head chip 41 is further improved. In addition, in the place where the distance between the flexible printed circuit boards 441, 442 and the common electrodes Edc1 in the ejection channels C1e, C2e is long, since the interconnection resistance of the common interconnections Wdc becomes lower, it becomes easier to prevent the unwanted heat generation from occurring. Further, as a result, the durability of the head chip 41 is further improved, and at the same time, the power consumption further decreases. Due to these circumstances, in particular in the present embodiment, it becomes possible to further enhance the reliability of the head chip 41. Further, since the common electrode Edc2 is formed in the entire area described above, the formation process of the common electrode Edc2 is simplified, and it becomes also possible to reduce the manufacturing cost of the head chip 41.

Here, further, in the present embodiment, as shown in FIG. 4, the common electrode Edc2 is formed on the bonding surface Sb by electrically connecting at least two or more common interconnections Wdc arranged side by side along the X-axis direction (the direction in which the plurality of ejection channels C1e, C2e is arranged side by side) to each other. Thus, the interconnection resistance in the common interconnections Wdc is further reduced, and at the same time, the variation in interconnection resistance in the common interconnections Wdc described above is also further suppressed compared to the case in which, for example, the two or more common interconnections Wdc along the X-axis direction are not electrically connected to each other. Therefore, in the present embodiment, it becomes possible to further enhance the reliability of the head chip 41 compared to such a case.

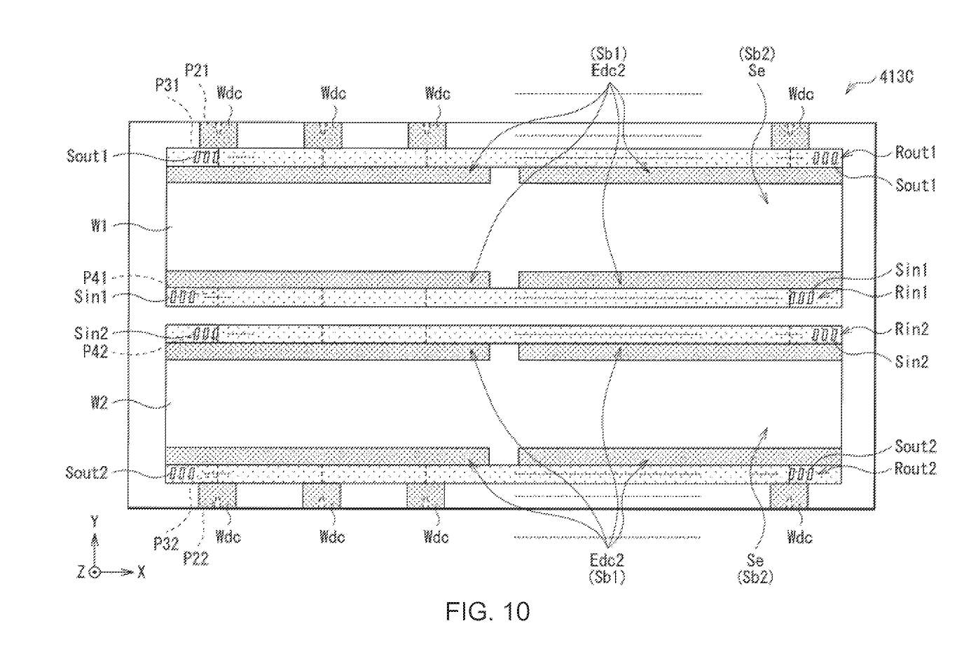

In particular in the present embodiment, as shown in FIG. 4, the common electrode Edc2 is formed on the bonding surface Sb by electrically connecting all of the common interconnections Wdc arranged side by side along the X-axis direction to each other. Thus, the interconnection resistance in the common interconnections Wdc is further reduced, and at the same time, the variation in interconnection resistance in the common interconnections Wdc described above is also further suppressed compared to the case in which, for example, only some of the common interconnections Wdc along the X-axis direction are electrically connected to each other as in the case of Modified Example 3 (see FIG. 10) described later. Therefore, in the present embodiment, it becomes possible to further enhance the reliability of the head chip 41 compared to such a case (e.g., Modified Example 3).

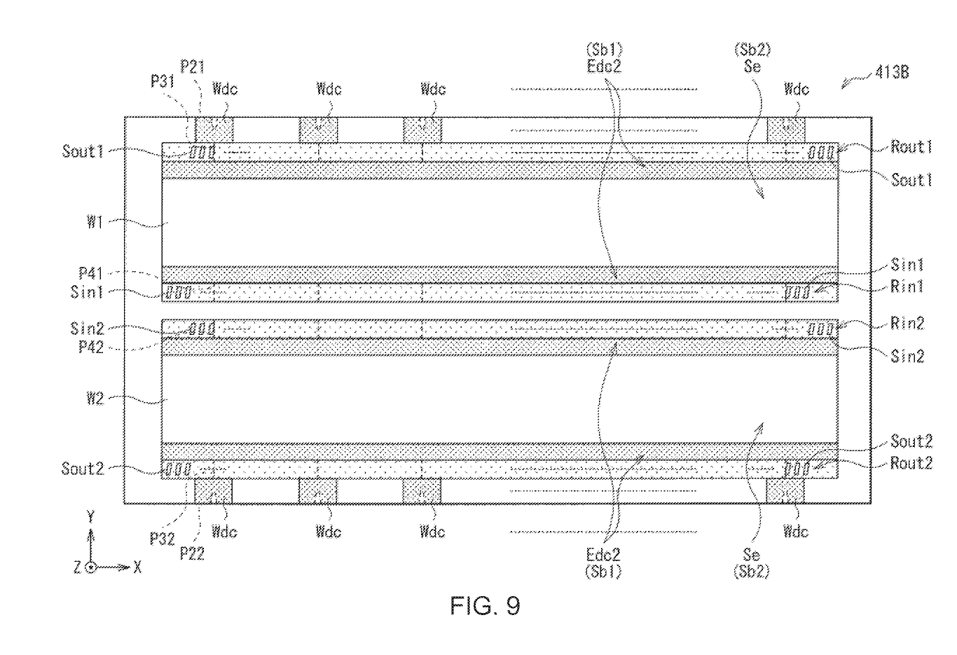

Further, in the present embodiment, as shown in FIG. 4 through FIG. 6, the common interconnections Wdc laid around from the inside of the entrance side common ink chamber Rin1 and the common interconnections Wdc laid around from the inside of the exit side common ink chamber Rout1 are electrically connected to each other along the Y-axis direction on the bonding surface Sb to thereby form the common electrode Edc2, and the common interconnections Wdc laid around from the inside of the entrance side common ink chamber Rin2 and the common interconnections Wdc laid around from the inside of the exit side common ink chamber Rout2 are electrically connected to each other along the Y-axis direction on the bonding surface Sb to thereby form the common electrode Edc2. Thus, the following can be achieved compared to the case in which such common interconnections Wdc are not electrically connected to each other along the Y-axis direction as in the case of, for example, Modified Examples 2, 3 (see FIG. 9 and FIG. 10) described later. That is, the interconnection resistance in the common interconnections Wdc is further reduced, and at the same time, the risk of the broken line on the common interconnections Wdc is reduced, and the risk of the connection failure between the common interconnections Wdc and the cover plate 413 or the external interconnection boards (e.g., the flexible printed circuit boards 441, 442) and so on is also reduced. Therefore, in the present embodiment, it becomes possible to further enhance the reliability of the head chip 41 compared to such a case (e.g., Modified Examples 2, 3).

### 2. Modified Examples

Then, some modified examples (Modified Example 1 through 3) will be described. It should be noted that the same constituents as those in the embodiment are denoted by the same reference symbols, and the description thereof will arbitrarily be omitted.

### Modified Example 1

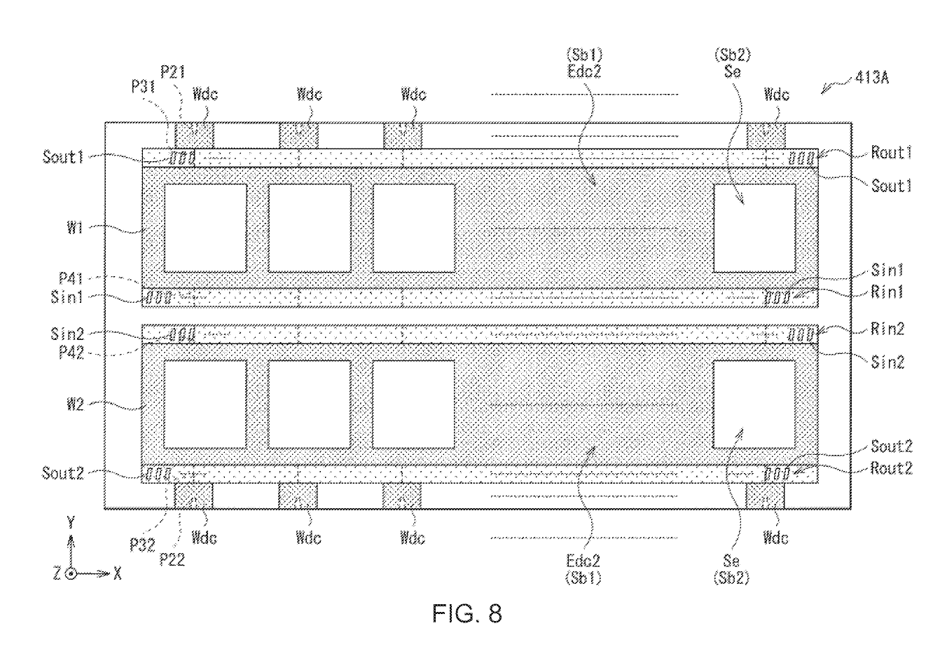

FIG. 8 is a diagram schematically showing a top surface configuration example (an X-Y top surface configuration example) of a cover plate (a cover plate 413A) in a head chip related to Modified Example 1. The cover plate 413A of Modified Example 1 corresponds to what is made to differ in the arrangement shape of the common electrode Edc2 in the cover plate 413 of the embodiment shown in FIG. 4, and the rest of the configuration is made basically the same.

Specifically, in the cover plate 413 (FIG. 4) of the embodiment, the common electrodes Edc2 are formed in the entire areas corresponding to the formation areas of the ejection channels C1e, C2e on the bonding surfaces Sb described above, respectively. In contrast, in the cover plate 413A of the present modified example, an area (an exposed surface Se described later) not provided with the common electrode Edc2 is disposed in a part of the bonding surface Sb.

More specifically, in the cover plate 413A, as shown in FIG. 8, some parts (bonding surfaces Sb2 described later) of the bonding surface Sb in each of the wall parts W1, W2 each form the exposed surface Se where the common electrode Edc2 is not formed, and the surface of the cover plate 413A is exposed. It should be noted that hereinafter, as shown in FIG. 8, in the bonding surface Sb in each of the wall parts W1, W2, the formation area of the common electrode Edc2 is referred to as a bonding surface Sb1, and at the same time, a non-formation area (a formation area of the exposed surface Se) of the common electrode Edc2 is referred to as the bonding surface Sb2.

Further, in particular in the cover plate 413A of the present modified example, as shown in FIG. 8, a plurality of such exposed surfaces Se is disposed on the bonding surface Sb, and at the same time, the plurality of exposed surfaces Se is disposed at regular intervals along the X-axis direction (the direction in which the plurality of ejection channels C1e, C2e is arranged side by side).

Here, the bonding surfaces Sb1, Sb2 each correspond to a specific example of the “surface on an opposite side (to the actuator plate in the wall part)” in the present disclosure.

It should be noted that similarly to the cover plate 413, in the cover plate 413A, the common electrode Edc2 is formed on the bonding surface Sb by electrically connecting at least two or more (all in this example) of the common interconnections Wdc arranged side by side along the X-axis direction to each other. Further, the common interconnections Wdc laid around from the inside of the entrance side common ink chamber Rin1 and the common interconnections Wdc laid around from the inside of the exit side common ink chamber Rout1 are electrically connected to each other along the Y-axis direction on the bonding surface Sb to thereby form the common electrode Edc2, and the common interconnections Wdc laid around from the inside of the entrance side common ink chamber Rin2 and the common interconnections Wdc laid around from the inside of the exit side common ink chamber Rout2 are electrically connected to each other along the Y-axis direction on the bonding surface Sb to thereby form the common electrode Edc2.

In the head chip of the present modified example provided with the cover plate 413A having such a configuration, it is also possible to obtain basically the same advantage due to the same function as that of the head chip 41 of the embodiment.

Further, in particular in the present modified example, as described above, some parts (the bonding surfaces Sb2) of the bonding surface Sb in each of the wall parts W1, W2 each form the exposed surface Se where the common electrode Edc2 is not formed, and the surface of the cover plate 413A is exposed. Thus, in the present modified example, in the case of, for example, bonding the upper surface (the bonding surface Sb) of the cover plate 413A to other members (e.g., the flow channel plate 40), since the common electrode Edc2 is not formed in the exposed surfaces Se, the adhesion force in the exposed surfaces Se is enhanced as a result. Specifically, in the case of the bonding surface Sb2 formed of the exposed surface Se, the adhesion force is enhanced as a result compared to the bonding surface Sb1 provided with the common electrode Edc2. This is because, since the common electrode Edc2 is attached afterward on the cover plate 413A, in the case of bonding an object on the common electrode Edc2, it becomes easier to separate the object compared to the case of bonding the object to the base material itself (the exposed surface Se) of the cover plate 413, and thus the adhesion force decreases. Therefore, in the present modified example, compared to the embodiment, since it is possible to increase the adhesion force in the whole of the bonding surface Sb with the other plates described above, the whole of the head chip becomes superior in durability. As a result, in the present modified example, it becomes possible to further enhance the reliability of the head chip.

Further, in the present modified example, as described above, the plurality of exposed surfaces Se is disposed on the bonding surface Sb, and at the same time, these exposed surfaces Se are arranged at regular intervals along the X-axis direction. Thus, in the present modified example, the following can be achieved compared to the case in which such a plurality of exposed surfaces Se is not arranged at regular intervals along the X-axis direction. Specifically, in the electrical connection part between the common interconnections Wdc laid around from the inside of the entrance side common ink chamber Rin1 and the common interconnections Wdc laid around from the inside of the exit side common ink chamber Rout1, and the electrical connection part between the common interconnections Wdc laid around from the inside of the entrance side common ink chamber Rin2 and the common interconnections Wdc laid around from the inside of the exit side common ink chamber Rout2, an increase in the interconnection resistance of the common interconnections Wdc can be suppressed. Therefore, in the present modified example, it is possible to further reduce the interconnection resistance in the whole of the common interconnections Wdc, and thus, it becomes possible to further enhance the reliability of the head chip compared to such a case. It should be noted that the case in which the exposed surfaces Se are arranged at regular intervals as in the present modified example is not a limitation, and it is also possible to arrange that, for example, the exposed surfaces Se are not arranged at regular intervals as described above.

### Modified Examples 2, 3

FIG. 9 is a diagram schematically showing a top surface configuration example (an X-Y top surface configuration example) of a cover plate (a cover plate 413B) in a head chip related to Modified Example 2. Further, FIG. 10 is a diagram schematically showing a top surface configuration example (an X-Y top surface configuration example) of a cover plate (a cover plate 413C) in a head chip related to Modified Example 3. The cover plates 413B, 413C of Modified Examples 2, 3 each correspond to what is made to differ in the arrangement shape of the common electrode Edc2 in the cover plate 413A of the Modified Example 1 described above, and the rest of the configuration is made basically the same.

Specifically, in the cover plate 413B of Modified Example 2 shown in FIG. 9, the exposed surface Se is disposed in a part (the bonding surface Sb2) of the bonding surface Sb in each of the wall parts W1, W2 in substantially the same manner as the cover plate 413A (FIG. 8) of Modified Example 1. It should be noted that unlike the cover plate 413A, in the cover plate 413B, the electrical connection between the common interconnections Wdc along the Y-axis direction is broken by a single exposed surface Se. In other words, in the cover plate 413B, although the common electrode Edc2 is formed on the bonding surface Sb by electrically connecting all of the common interconnections Wdc arranged side by side along the X-axis direction to each other, the electrical connection between the common interconnections Wdc is not achieved along the Y-axis direction.

On the other hand, in the cover plate 413C of Modified Example 3 shown in FIG. 10, the exposed surface Se is also disposed in a part (the bonding surface Sb2) of the bonding surface Sb in each of the wall parts W1, W2 in substantially the same manner as the cover plate 413A (FIG. 8) of Modified Example 1. It should be noted that unlike the cover plate 413A, in the cover plate 413C, the electrical connection between the common interconnections Wdc along the Y-axis direction is broken by a single exposed surface Se, and at the same time, the electrical connection between the common interconnections Wdc along the X-axis direction is also partially broken. In other words, in the cover plate 413C, although the common electrode Edc2 is formed on the bonding surface Sb by electrically connecting at least two or more common interconnections Wdc arranged side by side along the X-axis direction to each other, it is not true that all of common interconnections Wdc along the X-axis direction are electrically connected to each other.

As in Modified Examples 2, 3, the arrangement shapes, the numbers, and so on of the common electrodes Edc2 and the exposed surfaces Se on the bonding surface Sb of the cover plate can arbitrarily be set depending on the balance between, for example, the interconnection resistance of the common interconnections Wdc and the adhesion force of the whole of the bonding surface.

### 3. Other Modified Examples

The present disclosure is described hereinabove citing the embodiment and some modified examples, but the present disclosure is not limited to the embodiment and so on, and a variety of modifications can be adopted.

For example, in the embodiment described above, the description is presented specifically citing the configuration examples (the shapes, the arrangements, the number and so on) of each of the members in the printer, the inkjet head and the head chip, but those described in the above embodiment and so on are not limitations, and it is possible to adopt other shapes, arrangements, numbers and so on. Further, the values or the ranges, the magnitude relation and so on of a variety of parameters described in the above embodiment and so on are not limited to those described in the above embodiment and so on, but can also be other values or ranges, other magnitude relation and so on.

Specifically, for example, in the embodiment described above, the description is presented citing the inkjet head 4 of the two column type (having the two nozzle columns An1, An2), but the example is not a limitation. Specifically, for example, it is also possible to adopt an inkjet head of a single column type (having a single nozzle column), or an inkjet head of a multi-column type (having three or more nozzle columns) with three or more columns (e.g., three columns or four columns).

Further, for example, in the embodiment described above and so on, there is described the case in which the ejection channels (the ejection grooves) and the dummy channels (the non-ejection grooves) each extend along the oblique direction in the actuator plate 412, but this example is not a limitation. Specifically, it is also possible to arrange that, for example, the ejection channels and the dummy channels extend along the Y-axis direction in the actuator plate 412.

Further, for example, the cross-sectional shape of each of the nozzle holes H1, H2 is not limited to the circular shape as described in the above embodiment and so on, but can also be, for example, an elliptical shape, a polygonal shape such as a triangular shape, or a star shape.

In addition, in the embodiment and so on described above, the example of the so-called side-shoot type inkjet head fir ejecting the ink 9 from the central part in the extending direction (the oblique direction described above) of the ejection channels C1e, C2e is described, but the example is not a limitation. Specifically, it is also possible to apply the present disclosure to a so-called edge-shoot type inkjet head for ejecting the ink 9 along the extending direction of the ejection channels C1e, C2e.

Further, in the embodiment described above, the description is presented citing the circulation type inkjet head for using the ink 9 while circulating the ink 9 mainly between the ink tank and the inkjet head as an example, but the example is not a limitation. Specifically, it is also possible to apply the present disclosure to a non-circulation type inkjet head using the ink 9 without circulating the ink 9.

Further, the series of processes described in the above embodiment and so on can be arranged to be performed by hardware (a circuit), or can also be arranged to be performed by software (a program). In the case of arranging that the series of processes is performed by the software, the software is constituted by a program group for making the computer perform the function. The programs can be incorporated in advance in the computer described above, and are then used, or can also be installed in the computer described above from a network or a recording medium and are then used.

In addition, in the above embodiment, the description is presented citing the printer 1 (the inkjet printer) as a specific example of the “liquid jet recording device” in the present disclosure, but this example is not a limitation, and it is also possible to apply the present disclosure to other devices than the inkjet printer. In other words, it is also possible to arrange that the “head chip” and the “liquid jet head” (the inkjet heads) of the present disclosure are applied to other devices than the inkjet printer. Specifically, for example, it is also possible to arrange that the “head chip” and the “liquid jet head” of the present disclosure are applied to a device such as a facsimile or an on-demand printer.

In addition, it is also possible to apply the variety of examples described hereinabove in arbitrary combination.

It should be noted that the advantages described in the specification are illustrative only but are not a limitation, and another advantage can also be provided.

Further, the present disclosure can also take the following configurations.

<1>

A head chip adapted to jet liquid comprising an actuator plate having a plurality of ejection grooves arranged side by side along a first direction, and first common electrodes respectively formed in the ejection grooves; a nozzle plate having a plurality of nozzle holes individually communicated with the plurality of ejection grooves; and a cover plate adapted to cover the actuator plate, wherein the cover plate has a wall part adapted to cover the plurality of ejection grooves, a plurality of common interconnections electrically connected to the first common electrodes is laid around on a surface on an opposite side to the actuator plate in the wall part of the cover plate, and one of a single second common electrode and a plurality of second common electrodes on the surface on the opposite side of the wall part is formed by electrically connecting at least two or more of the common interconnections to each other on the surface on the opposite side of the wall part.

<2>

The head chip according to <1>, wherein one of the single second common electrode and the plurality of second common electrodes is formed, by electrically connecting the at least two or more of the common interconnections arranged side by side along the first direction.

<3>

The head chip according to <2>, wherein one of the single second common electrode and the plurality of second common electrodes is formed by electrically connecting all of the common interconnections arranged side by side along the first direction.

<4>

The head chip according to any one of <1> to <3>, wherein the cover plate further includes a first groove section including a first through hole through which the liquid flows between the ejection groove and the first groove section, and extending along the first direction, and a second groove section including a second through hole through which the liquid flows between the ejection groove and the second groove section, and extending along the first direction, the wall part is disposed in an area between the first groove section and the second groove section, and one of the single second common electrode and the plurality of second common electrodes is formed, by electrically connecting the common interconnections laid around from an inside of the first groove section and the common interconnections laid around from an inside of the second groove section to each other along a second direction crossing the first direction on the surface on the opposite side of the wall part.

<5>

The head chip according to any one of <1> to <4>, wherein a part of the surface on the opposite side in the wall part forms an exposed surface where the second common electrode is not formed but a surface of the cover plate is exposed.

<6>

The head chip according to <5>, wherein a plurality of the exposed surfaces is provided, and the exposed surfaces are arranged at regular intervals along the first direction.

<7>

The head chip according to any one of <1> to <4>, wherein the surface on the opposite side of the wall part, the second common electrode is formed in an entire area corresponding to a formation area of the ejection grooves.

<8>

The head chip according to any one of <1> to <7>, wherein the liquid circulates between an inside of the head chip and an outside of the head chip, the cover plate further includes a first groove section including a first through hole adapted to inflow the liquid into the ejection groove, and extending along the first direction, and a second groove section including a second through hole adapted to outflow the liquid from the ejection groove, and extending along the first direction, and the wall part is disposed in an area between the first groove section and the second groove section.

<9>

A liquid jet head comprising the head chip according to any one of <1> to <8>.

10>

A liquid jet recording device comprising the liquid jet head according to <9>; and a containing section adapted to contain the liquid.

What is claimed is:

1. A head chip adapted to jet liquid comprising:
an actuator plate having a plurality of ejection grooves arranged side by side along a first direction, and first common electrodes respectively formed in the ejection grooves;
a nozzle plate having a plurality of nozzle holes individually communicated with the plurality of ejection grooves; and
a cover plate adapted to cover the actuator plate,
wherein the cover plate has a wall part adapted to cover the plurality of ejection grooves,
a plurality of common interconnections electrically connected to the first common electrodes is laid around on a surface on an opposite side to the actuator plate in the wall part of the cover plate, and
one of a single second common electrode and a plurality of second common electrodes on the surface on the opposite side of the wall part is formed by electrically connecting at least two or more of the common interconnections to each other on the surface on the opposite side of the wall part.

2. The head chip according to claim 1, wherein
one of the single second common electrode and the plurality of second common electrodes is formed, by electrically connecting the at least two or more of the common interconnections arranged side by side along the first direction.

3. The head chip according to claim 2, wherein
one of the single second common electrode and the plurality of second common electrodes is formed by electrically connecting all of the common interconnections arranged side by side along the first direction.

4. The head chip according to claim 1, wherein
the cover plate further includes
a first groove section including a first through hole through which the liquid flows between the ejection groove and the first groove section, and extending along the first direction, and
a second groove section including a second through hole through which the liquid flows between the ejection groove and the second groove section, and extending along the first direction,
the wall part is disposed in an area between the first groove section and the second groove section, and
one of the single second common electrode and the plurality of second common electrodes is formed, by electrically connecting the common interconnections laid around from an inside of the first groove section and the common interconnections laid around from an inside of the second groove section to each other along a second direction crossing the first direction on the surface on the opposite side of the wall part.

5. The head chip according to claim 1, wherein
a part of the surface on the opposite side in the wall part forms an exposed surface where the second common electrode is not formed but a surface of the cover plate is exposed.

6. The head chip according to claim 5, wherein
a plurality of the exposed surfaces is provided, and
the exposed surfaces are arranged at regular intervals along the first direction.

7. The head chip according to claim 1, wherein
in the surface on the opposite side of the wall part, the second common electrode is formed in an entire area corresponding to a formation area of the ejection grooves.

8. The head chip according to claim 1, wherein
the liquid circulates between an inside of the head chip and an outside of the head chip,
the cover plate further includes
a first groove section including a first through hole adapted to inflow the liquid into the ejection groove, and extending along the first direction, and
a second groove section including a second through hole adapted to outflow the liquid from the ejection groove, and extending along the first direction, and
the wall part is disposed in an area between the first groove section and the second groove section.

9. A liquid jet head comprising the head chip according to claim 1.

10. A liquid jet recording device comprising:
the liquid jet head according to claim 9; and
a containing section adapted to contain the liquid.
